(19) United States
(12) Patent Application Publication
(10) Pub. No.: US 2001/0033444 A1
(43) Pub. Date: Oct. 25, 2001

(54) Signal processing circuit free from erroneous data and the information storage apparatus including the signal processing circuit

(75) Inventors: Futoshi Tomiyama, Hachioji (JP); Hitoshi Yoshida, Odawara (JP); Ryutaro Horita, Takasaki (JP); Hideki Sawaguchi, Kokubunji (JP)

Correspondence Address: Edward W. Greason, Kenyon & Kenyon, One Broadway, New York, NJ, 10004, US

(73) Assignee: Hitachi, Ltd.

(21) Appl. No.: 09/810,637

(22) Filed: Mar. 16, 2001

(30) Foreign Application Priority Data
Apr. 7, 2000 (JP) 2000-206832

(51) Int. Cl. G11B 5/02; G11B 19/04

(52) U.S. Cl. 360/29; 360/60

(57) ABSTRACT

A magnetic storage apparatus is provided with unit for identifying the frequency of overwriting storage at the time of overwriting in the same data sector, and depending on the frequency of overwriting, a code for coding or a scrambler initial value is changed at every overwrite operation. The modulation code has the same code rate so that a data length does not change at every write operation. A number corresponding to the present modulation code of each data sector is stored on a memory, and the aforesaid number is also written as an additional bit in the data sector on a medium. Data are read only when the modulation coding number on the memory and the modulation coding number on the medium, which are compared, agree with each other. If they do not agree, offset reading is performed until they agree, and then the read operation is performed.

### BACKGROUND OF THE INVENTION

1. Field of the Invention

The present invention relates to a method to prevent misread of previously recorded data which are to be overwritten in an information storage apparatus.

2. Description of the Related Art

The information storage apparatus, e.g., a magnetic storage apparatus, is required to correctly read recorded information in its process of reading written data. But, if an abnormal condition occurs, for example, a significant shock or the like is applied to the apparatus, a write head is heavily displaced from a predetermined track. And, it was found that the recorded information might be misread under the aforesaid abnormal condition. Such a phenomenon (hereinafter called erroneous data) will be described.

FIG. 1 shows a general view of a typical magnetic storage apparatus. The magnetic storage apparatus of FIG. 1 is comprised of a preamplifier 1 which amplifies a read signal, a magnetic recording medium 2 which is fixed to a cylinder for magnetically recording and keeping information, a magnetic head having a read/write element for reading the magnetized information recorded on the recording medium, and a rotary actuator 4 for positioning of the magnetic head.

FIG. 2 shows a sectional diagram of the magnetic storage apparatus shown in FIG. 1. A package board 5 has a motor driver 23 for driving a spindle motor and an actuator for spinning the magnetic disk, a microprocessor 21 for performing various kinds of arithmetic operations, a signal processing channel chip (signal processing circuit) 22, and a memory 20. The read signal from the preamplifier 1 is processed by the signal processing circuit 22.

FIG. 3 shows a schematic diagram of a write head and a read head of the magnetic head, and FIG. 4 shows a sectional diagram of a composite head. As shown in FIG. 4, the composite head has a read head 7 and a write head 6. The write head has a coil, and information can be written on the recording medium 2 by a magnetic field generated by an alternating recording current flown to the coil.

A plurality of tracks having servo sectors and data sectors are disposed on the magnetic recording medium. FIG. 5 shows how the servo area, which is used for positioning of the head, and the data area, where user data are recorded, are formed on an actual magnetic recording medium. Each track is comprised of a servo area 11, a data area 13 and a gap 12 as shown in FIG. 5. Such a track forms a unit and generally consists of about 60 to 120 servo areas in one round.

An example of the servo pattern written on the servo area is shown in FIG. 6(a). The servo area 11 is comprised of ISG 16 for tuning the signal amplitude, a gray code 17 for identifying a track number, a servo burst 18 for obtaining position information in an off-track direction, and a PAD 19 located in front of the data area so that an automatic gain controller does not oscillate. The servo bust 18 is generally comprised of A-burst 15-1, B-burst 15-2, C-burst 15-3 and D-burst 15-4.

FIG. 6(b) shows the waveform at the servo area when the read element of the magnetic head is positioned over a track 14-3 of FIG. 6(a). The magnetic storage apparatus performs servo-following to the tracks according to the burst patterns as shown in FIG. 6(a). For example, when the following is performed to the center of the track 14-3 of FIG. 6(a), the head is positioned so that a difference between the signal amplitude at A-burst and that at B-burst becomes zero.

FIG. 17 is a flow chart showing a write operation according to a related prior art. A write command is received from a controller, and a rotary actuator is operated to make the magnetic head seek a target track. According to the position signal demodulated from the servo signal, the target position and the head's present position are compared so to position the head at the target position. When the head reaches the target position, it is determined as a state of write operation ready.

Meanwhile, a write pattern corresponding to the user data is produced, and the write pattern is scrambled according to a single scrambler initial value. Scrambling here means conversion of the above write pattern in conformity with particular rules, and means or a circuit for scrambling or algorithm is called a scrambler. A signal processing system of the magnetic storage apparatus has a particular signal pattern which is inherent in the apparatus and hardly decoded, but it has an effect of making the probability of the generation of such a signal pattern lower by scrambling. The scrambled write data are coded in a single code, and the aforesaid generated pattern is written from the write amplifier onto the medium through the write head.

FIG. 16 shows an example of the scramble structure having the following scrambler polynominal:

Xˆ 10+Xˆ 7+Xˆ 0.

As shown in FIG. 16, a value having 1 or 0 corresponded to each of X0 to X9 is determined as a scrambler initial value, and a scramble is effected by exclusive OR. In this example, there are 2ˆ 10−1 combinations of initial values or 1023 combinations excluding a case that all of X0 to X9 become 0. Generally, a given static data sector is scrambled with a single value among them determined as an initial value.

FIG. 18 is a flow chart showing a read operation according to a related prior art. A read command is received from the controller, and the rotary actuator is operated to make the magnetic head seek a target track. According to the position signal demodulated from a servo signal, the target position and the head's present position are compared to position the head at the target position. When the head reaches the target position, it is determined as a state of read operation ready.

Then, a data sequence written on the medium is read through the read head and the read amplifier, and the read signal is sent to the signal processing circuit to perform signal processing of a waveform. And, decoding is performed in conformity with the coding rules used for writing, and information is read by descrambling which is consistent with the initial value used for writing.

The magnetic disk unit generally overwrites to rewrite data. FIGS. 7(a), 7(b) and 7(c) show explanatory diagrams of a partially unerased phenomenon of the previously recorded state at the time of overwrite storage. FIG. 7(a) shows a previously recorded state. Broken lines indicate a previously recorded state, showing that writing on a track is made in an oscillation range with a level of positioning accuracy. FIG. 7(b) shows a state that new information is overwritten on the previously recorded state. Broken lines in FIG. 7(b) indicate the same previously recorded state as shown in FIG. 7(a), and solid lines indicate the overwritten new information. The write head position at the previous recording and the write head position at the new information recording do not agree completely because of an error of positioning accuracy level. Therefore, the previously recorded state remaining after the overwriting of new information remains partly unerased at the edges of the track as shown in FIG. 7(c). The unerased area degrades an error rate especially at the off track position.

FIGS. 8(a), 8(b) and 8(c) are explanatory diagrams showing a partly unerased phenomenon of the previously recorded state at the time of overwriting storage because a largely offset record was made at the previous recording. It is seen that there remains a large area of a largely offset record made at the time of previous recording and it is different from the state shown in FIGS. 7(a)-7(c) that there are small unerased areas along the track edges. Such a large unerased area has a possibility that the previously recorded data themselves are erroneously read. That leads to erroneous data in addition to the simple degradation of the error rate seen in FIGS. 7(a)-7(c).

A mechanism of generating the erroneous data will be described with reference to FIG. 9. FIG. 9 shows a state that new data are overwritten in a state mispositioned in an opposite direction on the previous data which are recorded in a heavily mispositioned state. Even in such an extreme situation, data can be read correctly when the read head passes over new data as indicated by (1) in FIG. 9. But, when the head passes over the previously recorded data as indicated by (2) in FIG. 9, the previously recorded data might be erroneously read as correct information. Misread under the situation of (2) above tends to cause erroneous data because ECC (Error Correction Code) does not operate effectively, and if ECC is reinforced, even a small volume of previously recorded data is read.

For complete inhibition of such erroneous data, there are the following two methods for example.

(1) Write inhibit slice is determined small.

(2) The read track width is designed to be large.

The write inhibit slice denotes a predetermined threshold value to indicate that the write operation is stopped when the magnetic head's present position and the target position exceed the above threshold value. In order to prevent information from being erased erroneously by overwriting because of a large off-track caused by a shock or the like, the conventional magnetic storage apparatus is often provided with the capability of stopping the write head from write-operating according to the position information of the magnetic head if a difference between the target position and the present position is larger than a predetermined slice level. Such a slice level is called the write inhibit slice as above.

When the write inhibit slice as indicated by (1) above is determined small, write ready is not established until sufficient positioning accuracy is determined, resulting in degradation of effective data throughput of the apparatus. And, when the read track width is designed large as indicated by (2) above, it becomes easy to cause adjacent crosstalk and to read the previously recorded data, and an error rate is degraded. And, an uncorrectable error might be caused in some cases. Accordingly, an erroneous data prevention method, which prevents erroneous data, and does not cause degradation in a throughput, degradation in an error rate or a prevention of an uncorrectable error, is demanded.

### SUMMARY OF THE INVENTION

Under the circumstances described above, it is an object of the present invention to provide an erroneous data prevention method which prevents erroneous data and does not cause a degradation in throughput, a degradation of error rate or a prevention of uncorrectable error, and a magnetic storage apparatus which is provided with measures for erroneous data.

To perform a write operation, the information storage apparatus of the invention changes a coding form depending on a frequency of overwriting in the same designated data sector at every overwrite operation. The modulation code is determined to have the same code rate so that a data length does not change at every write operation. The code rate means a ratio between a data sequence length before data conversion and that after the data conversion. For example, a 16/17 modulation code often used for the recent magnetic disk units is a generic name for a code used for conversion of a data sequence of 16 bits in length to a data sequence of 17 bits in length, and a plurality of achievement methods are available.

As means for changing the coding form, a plurality of different coding circuits are provided, any of the plurality of circuits is designated at a write operation, the coding circuits are switched, and user data are input to change a coding form. It may also be designed to make coding of the user data by storing a plurality of different coding signal processing procedures in first storage such as a register or a memory and designating any of a coding form at the time of a write operation. It may also be designed to previously link the plurality of coding circuits or coding procedures to the frequency of overwriting, to count the frequency of overwriting in the same data sector by a counter, and to designate the coding circuits or the coding procedures in view of a numeric value counted by the counter.

At the write operation, the aforesaid coding form is changed to write as described above, and information corresponding to the designated coding circuit or the coding procedure and position information of each data sector are stored in second storage disposed independent of the first storage. At the same time, the aforesaid information is written as an additional bit in the data sector provided on the medium. As information corresponding to the designated coding circuit or the coding form, for example a serial number may be allotted to the plurality of coding circuits or the coding form. And, a number corresponding to a specific coding circuit or coding form may be used as information.

At data reading, the aforesaid information stored in the second storage means and the aforesaid information written on the data sector where the read operation is performed are compared, and the read operation is performed only when they agree with each other. If they do not agree, offset reading is performed until the number stored in the second storage and the number in the data sector where the read operation is performed agree with each other, and the read operation is continued. As the position information of the data sector, for example an identification code such as ID (a code indicating track and sector numbers) and CHS (a code indicating cylinder, head and sector numbers) may be stored in the second storage.

The aforesaid form changes the coding form every overwrite storage, but the same effect can be provided by changing a scrambler initial value at every overwrite storage without changing the coding rule. Specifically, a plurality of scrambler initial values is previously stored in the storage, and any of the plurality of scrambler initial values is designated to scramble the user data. The second storage are provided independent of the aforesaid storage, and at the write operation, the scrambler initial values are written in the data sector on the medium and the position information of the data sector and the scrambler initial values are written on the storage. And, at the read operation, their agreement is checked before reading. Because the scrambler initial values are merely changed, the code rate as the data sequence to be actually written does not change. Information for distinguishing/referring the plurality of scrambler initial values, such as assignment of a number, may be used instead of a scrambler initial value, so that such information may be written in the second storage.

As described above, the plurality of scrambler initial values and the frequency of overwriting can be previously linked, so that the frequency of writing to the same data sector is counted by the counter, and the scrambler initial value may be designated in view of the number counted by the counter.

In the above description, the first storage and the second storage are distinguished from each other, but the same storage may be shared to provide a different storage area for the first storage and the second storage. And, the first storage and the second storage may be any type of storage as long as it can store information. In other words, the first storage and the second storage may be a register or a cache memory disposed in the signal processing circuit, or a portion of the memory disposed in the apparatus. Another memory such as DRAM or a flash memory may also be disposed.

### BRIEF DESCRIPTION OF THE DRAWINGS

FIG. 1 is a general diagram of a magnetic disk unit;

FIG. 2 is a sectional diagram of the magnetic disk unit;

FIG. 3 is a magnified view of a magnetic head for writing and reading in the magnetic disk unit;

FIG. 4 is a sectional diagram of the magnetic head;

FIG. 5 is a structural diagram of a servo area and a data area in a single track;

FIGS. 6(a) and 6(b) are explanatory diagrams of the servo area;

FIGS. 7(a), 7(b) and 7(c) are explanatory diagrams of a not erased area of the previously recorded state at overwriting storage;

FIGS. 8(a), 8(b) and 8(c) are explanatory diagrams of the not erased area of the previously recorded state at overwriting storage after the previous recording was heavily offset;

FIG. 9 is an explanatory diagram of a mechanism to cause erroneous data;

FIG. 10 is a diagram showing a write operation according to a first embodiment of the invention;

FIG. 11 is a diagram showing a read operation according to the first embodiment of the invention;

FIG. 12 is a diagram showing an example of a recorded state according to the first embodiment of the invention;

FIG. 13 is a diagram showing an example of a recorded state according to a second embodiment of the invention;

FIG. 14 is a diagram showing a write operation according to the second embodiment of the invention;

FIG. 15 is a diagram showing a read operation according to the second embodiment of the invention;

FIG. 16 is a scrambler configuration example;

FIG. 17 is a flow chart of a write operation according to a related prior art; and

FIG. 18 is a flow chart of a read operation according to the related prior art.

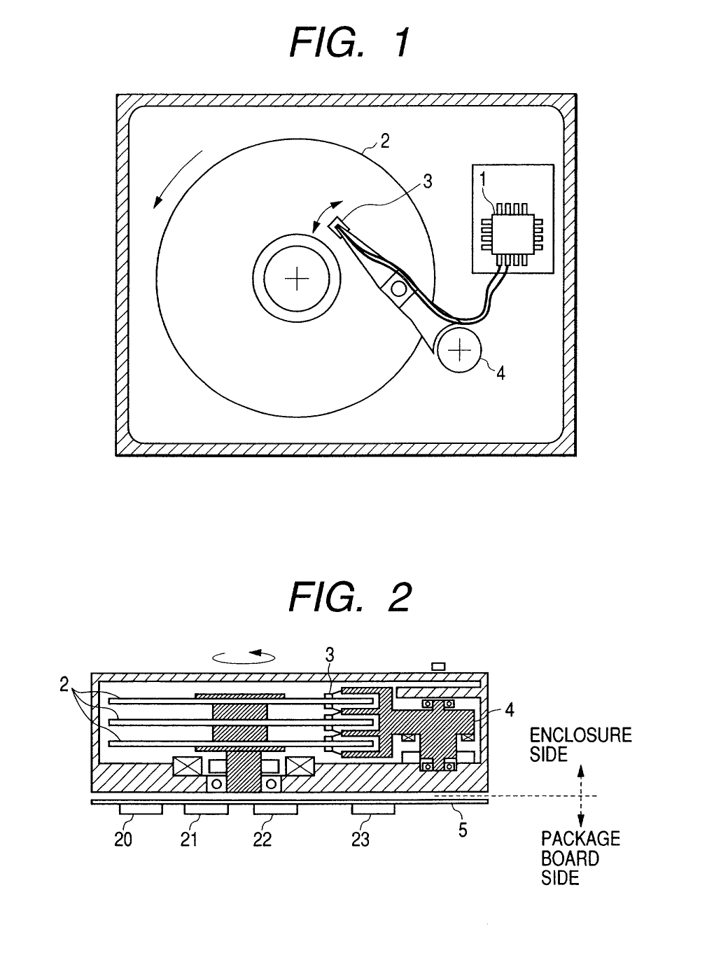

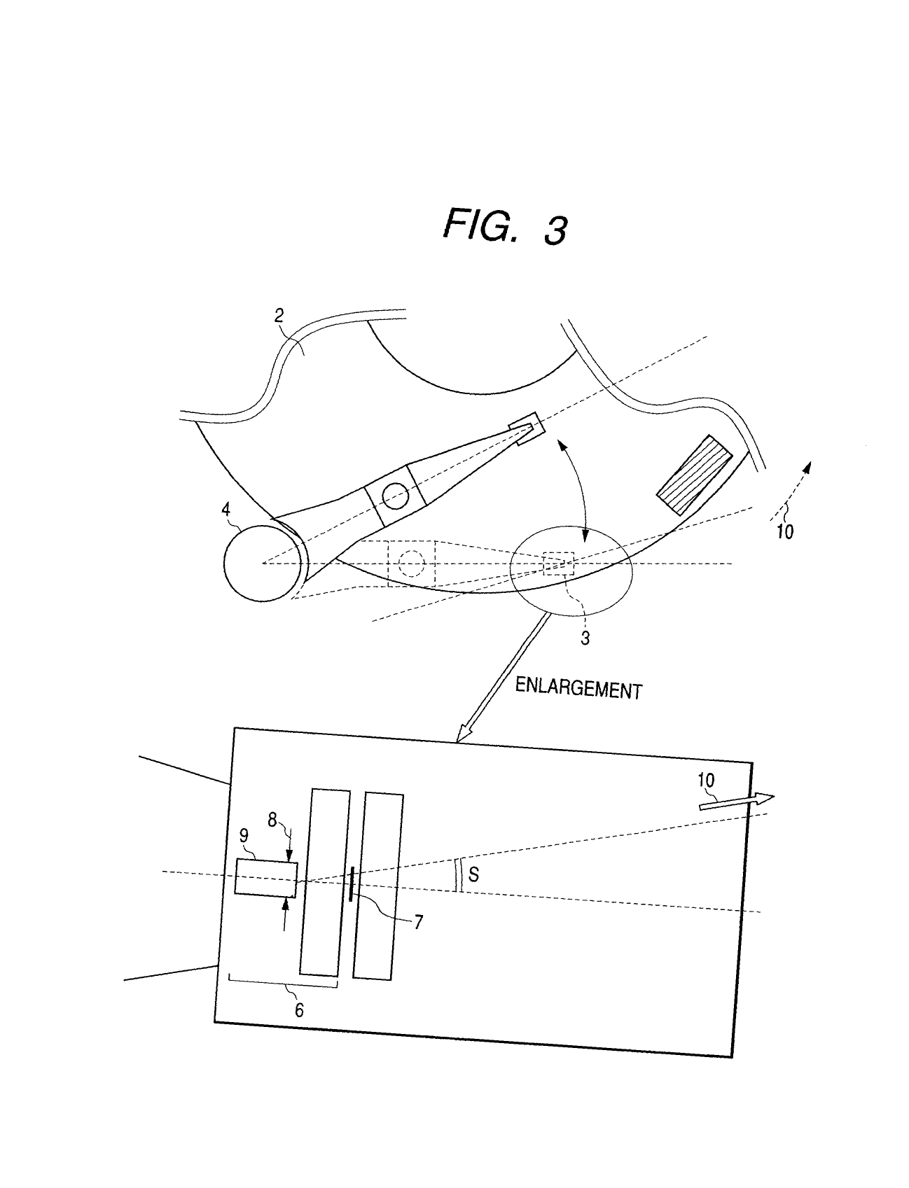

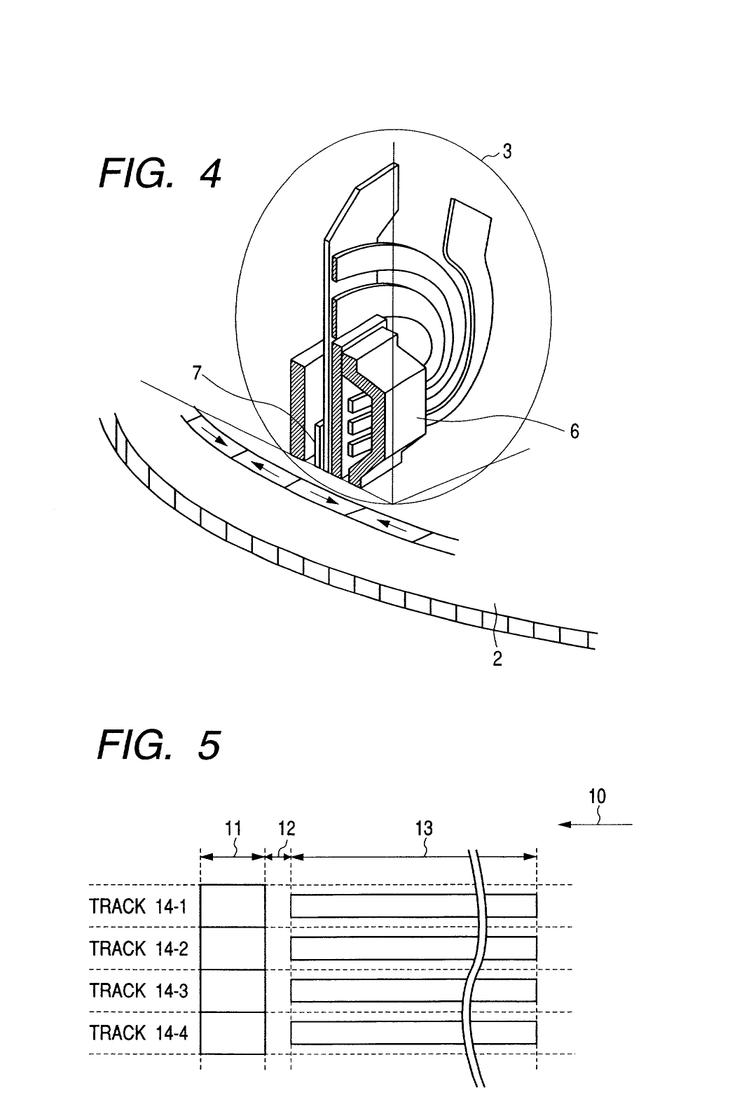

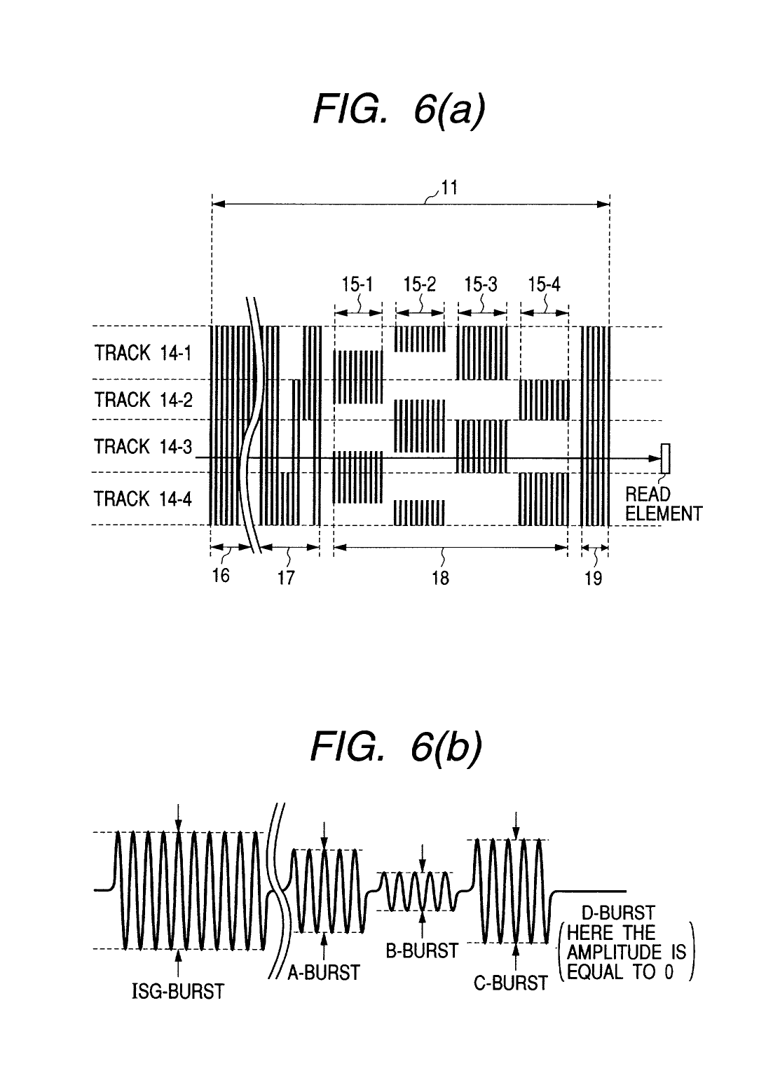

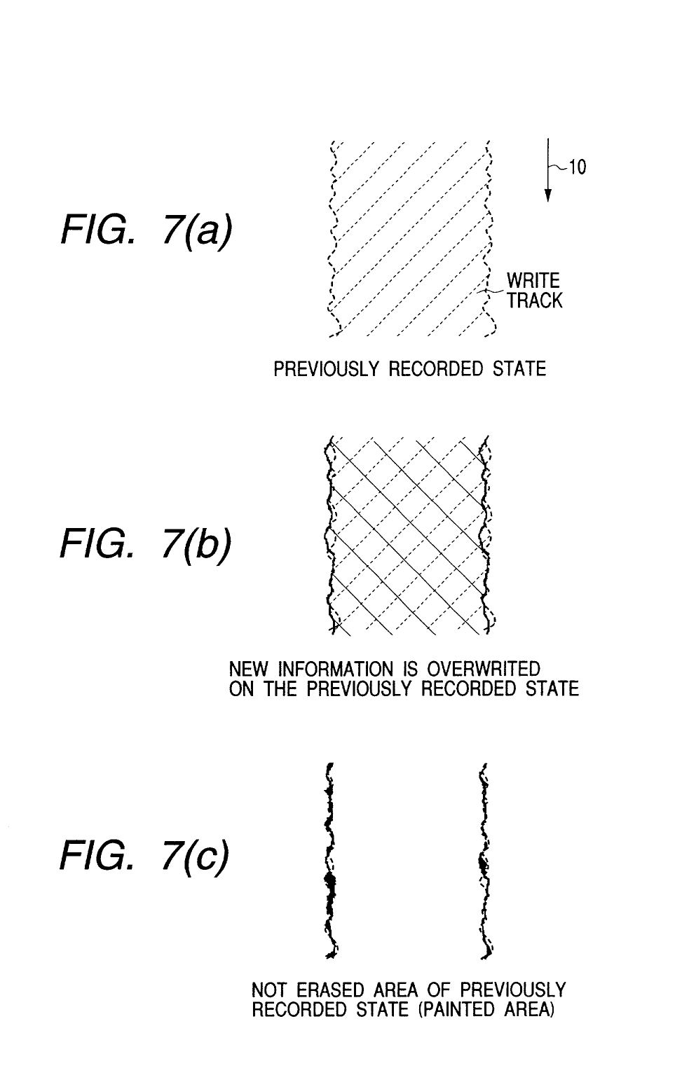

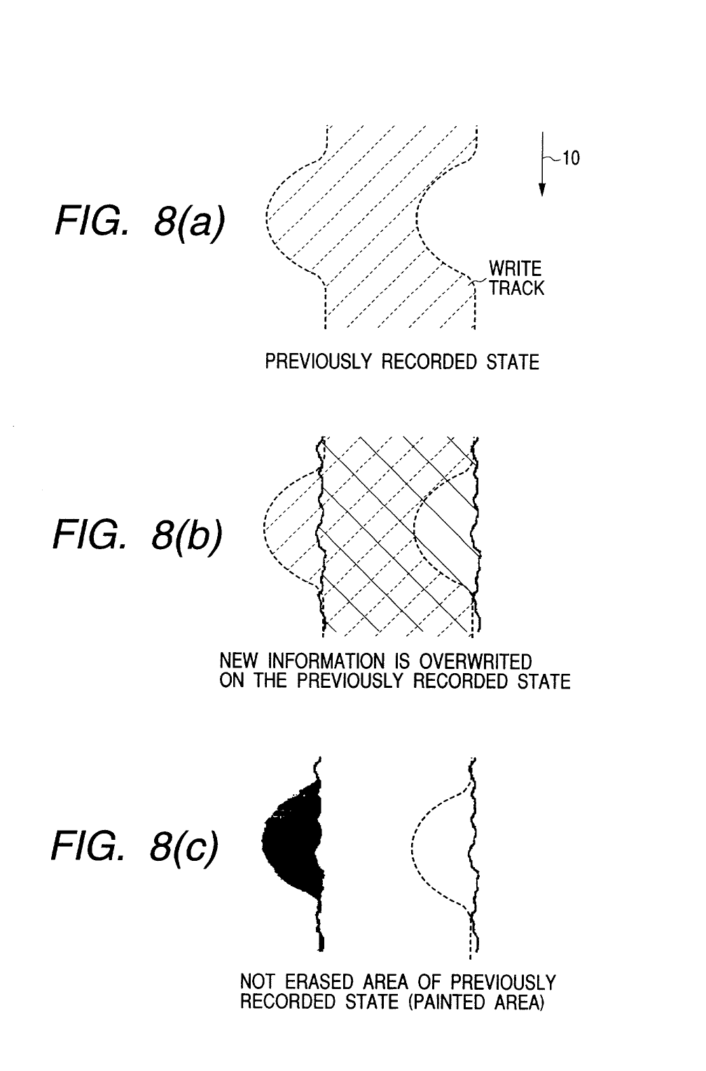

### DETAILED DESCRIPTION OF THE EMBODIMENTS

Embodiment 1

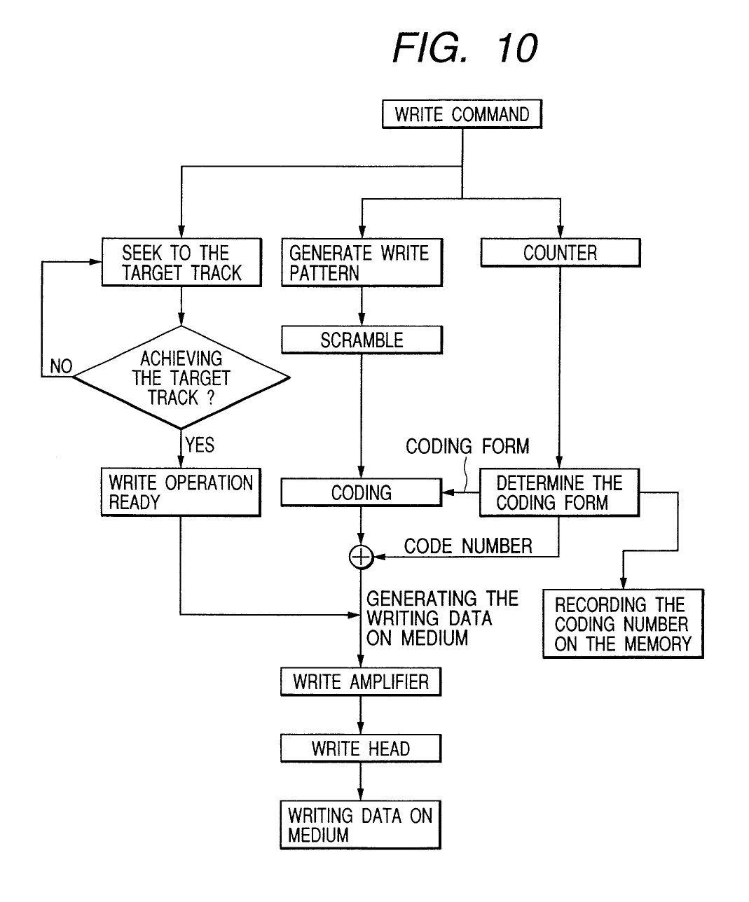

FIG. 10 shows a flow chart of a write operation according to the first embodiment of the invention. A rotary actuator is operated upon receiving a write command from a controller, and a magnetic head is caused to seek a target track. According to a position signal demodulated from a servo signal, the target position and the head's present position are compared so to position the head at the target position. When the magnetic head reaches the target position, it is determined as a state of write operation ready.

Meanwhile, a write frequency from the controller to the data sector, namely the number of overwriting in the same sector, is monitored by a counter, and a coding form is determined depending on the number counted by the counter. The counted number and data sector position information are recorded on a second memory at every write operation. As position information of the data sector, CHS is used in the embodiment. Three different coding forms are recorded on a first memory, and numbers 1 to 3 (hereinafter called coding number) are allotted to the three coding forms. The coding numbers are corresponded with the number of write operation counted by the counter, and the coding forms are selected sequentially so that the same coding number does not repeat. The three coding forms used in the specification have a code rate of 16/17.

After a record pattern corresponding to user data is generated and scrambled, the aforesaid designated coding form is used to apply coding to the record pattern. Thus, the coding form to be applied to each overwrite operation can be changed by selecting a coding form.

CHS and the coding numbers are recorded on the second memory, and the coding number is also added as an additional bit to the generated record pattern. The additional bit may be positioned at the front or rear of the user data sequence having undergone the coding. The record pattern having the additional bit is recorded from the write amplifier onto the medium through the write head. Thus, the coding number is recorded in the data sector.

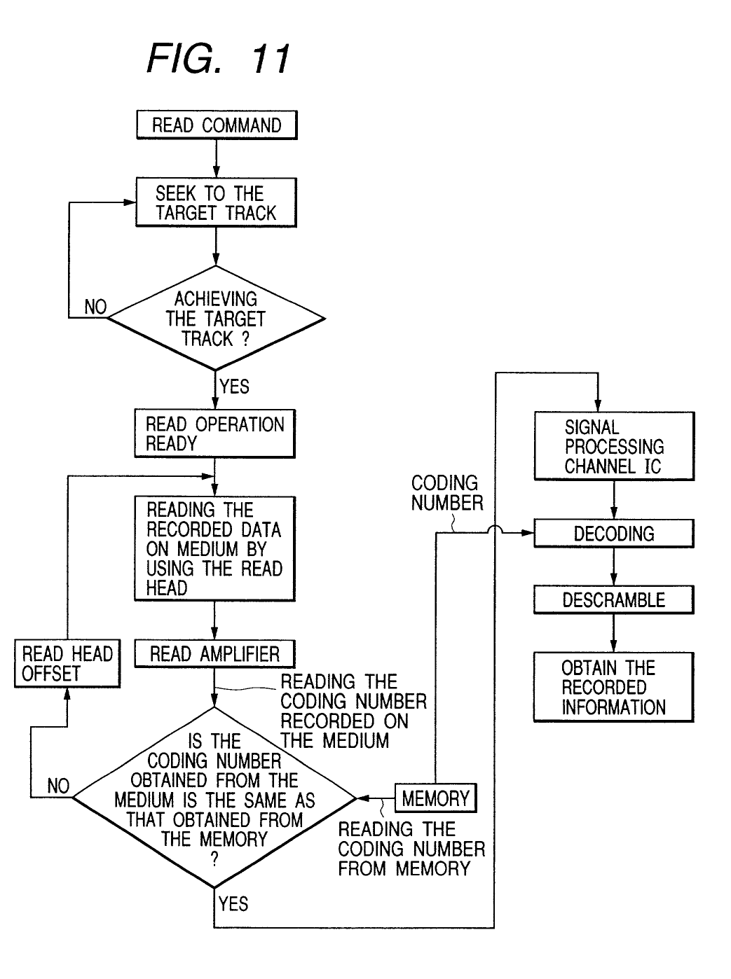

FIG. 11 shows a flow chart of the read operation. Its read procedure corresponds to the aforesaid write operation. A read command is received from the controller, and the rotary actuator is operated to make the magnetic head seek a target track. According to the position signal demodulated from the servo signal, the target position and the head's present position are compared to position the head at the target position. When the magnetic head reaches the target position, it is determined as a state of read operation ready.

Then, the coding number recorded in the data sector on the medium is read through the read head and the read amplifier, and the position information of the data sector and the coding number stored in the memory are compared to check whether both coding numbers agree with each other. If they do not agree, the read head is offset, and the procedure is repeated until the coding number read from the medium agrees with the number recorded on the memory. If the numbers agree with each other, a read signal is sent to the signal processing circuit 22 to make signal processing of a waveform. And, according to the coding rules conforming to the coding number, decoding is performed to read information after descrambling.

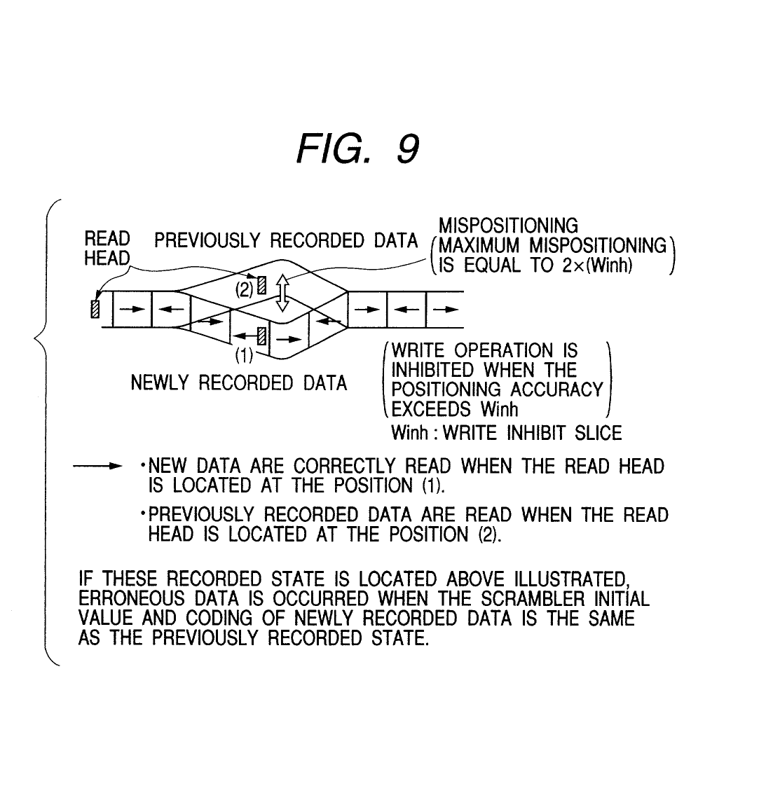

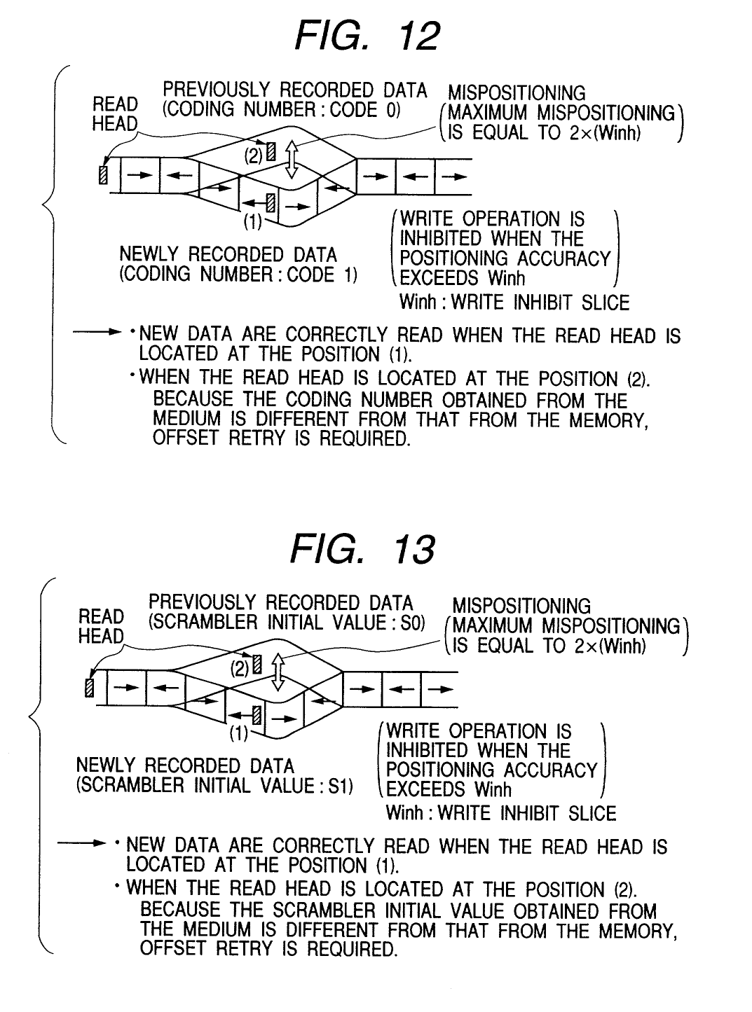

By employing the aforesaid write/read form, even when the read head is positioned over the previously recorded data as indicated by (2) in FIG. 12, the coding number read from the medium becomes different from the coding number recorded on the memory without erroneously reading the previously recorded data as in the related prior art (FIG. 9), and retry is urged by offset reading, so that erroneous data can be prevented.

Embodiment 2

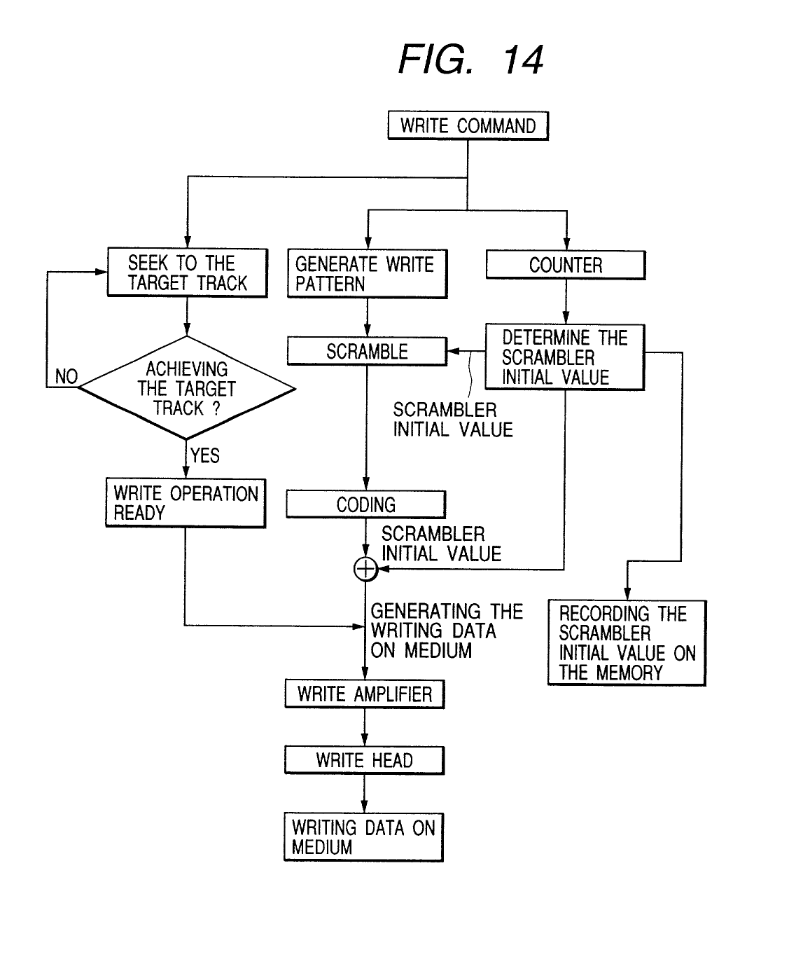

FIG. 14 shows a flow chart of a write operation according to the second embodiment of the invention. A write command is received from the controller, and the rotary actuator is operated to make the magnet head seek a target track. According to the position signal demodulated from a servo signal, the target position and the head's present position are compared to position the head at the target position. When the magnetic head reaches the target position, it is determined as a state of write operation ready.

Meanwhile, a frequency of overwriting in the data sector from the controller is monitored by the counter, and a scrambler initial value is determined from the number indicated by the counter. To change the scrambler initial value, a plurality of scrambler initial values are previously kept in a register within the signal processing circuit, and the respective scrambler initial values are allotted according to the overwriting frequencies counted by the counter. At every write operation, the counted overwrite frequencies and the position information of the data sector are stored in a memory different from the register. Because a scrambler initial value is merely changed, a code rate as the data sequence to be actually recorded does not change. The user data sequence is scrambled by generating a write pattern corresponding to the user data and using the plurality of scrambler initial values allotted according to the overwrite frequencies. In other words, the scrambler initial value to be applied at every write operation is changed.

At the same time, the scrambler initial value used in the data sector and the position information of the data sector are stored in the memory. Then, coding is performed, and a scrambler initial value is also added as an additional bit to the generated write pattern. The adding position may be at the front or rear of the coded data sequence. The aforesaid generated pattern is written from the write amplifier onto the medium through the write head.

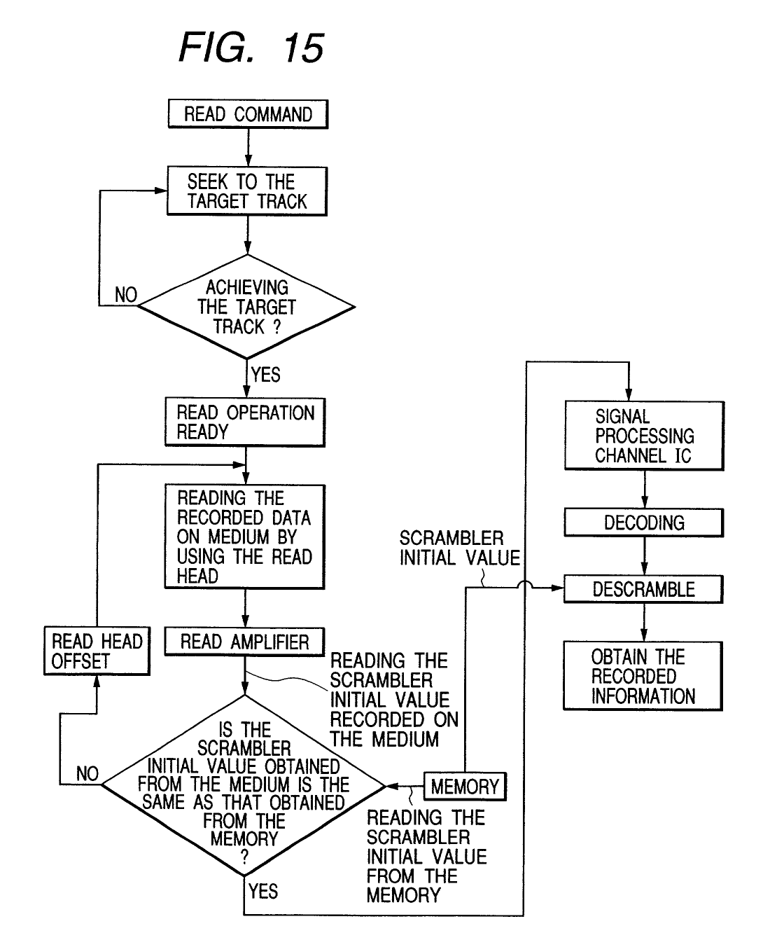

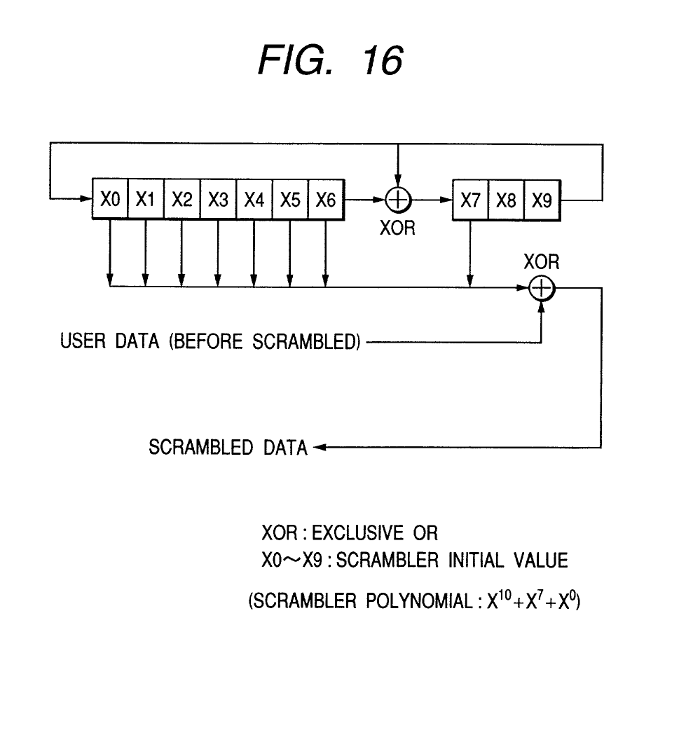

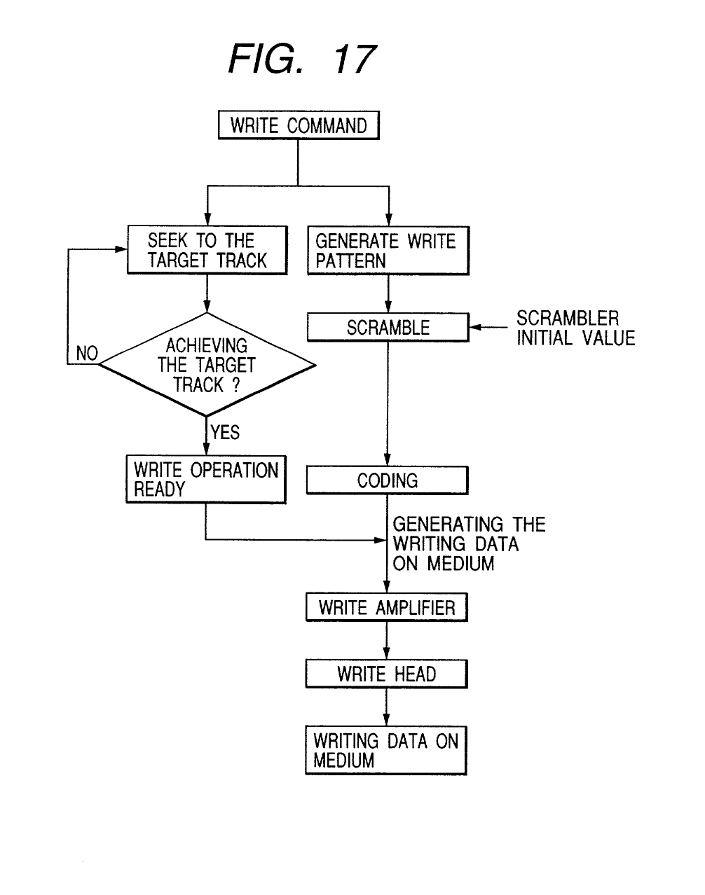

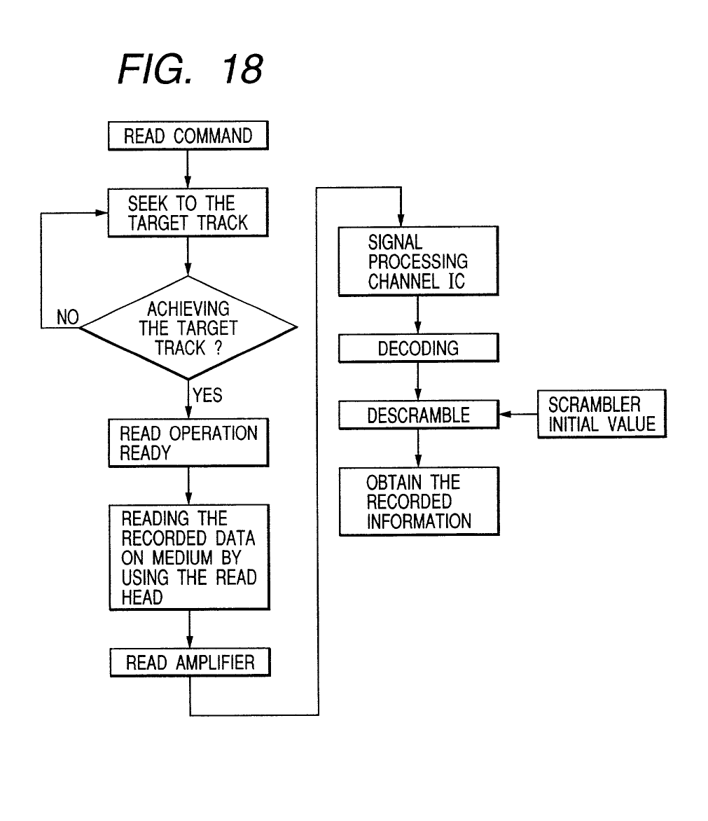

FIG. 15 shows a flow chart of the read operation. It is a read procedure corresponding to the aforesaid write operation. A read command is received from the controller, and the rotary actuator is operated to make the magnetic head seek a target track. According to the position signal demodulated from a servo signal, the target position and the head's present position are compared to position the magnetic head at the target position. When the magnetic head reaches the target position, it is determined as a state of write operation ready.

Then, the scrambler initial value written in the data sector on the medium is read through the read head and the read amplifier, compared with a scrambler initial value written of the data sector in the memory to check whether the initial values agree with each other. If they do not agree, the read head is offset, and the procedure is repeated until the scrambler initial value read from the medium agrees with a value written in the memory. If the values agree with each other, the read signal is sent to the signal processing circuit to perform signal processing of the waveform. Decoding is performed according to a predetermined code, and descrambling is performed in conformity with the scrambler initial value used at the write operation to read information.

By the aforesaid write/read form, even when the read head is positioned over the previously recorded data as indicated by (2) in FIG. 13, erroneous data can be prevented from occurring because retry is continued by offset reading until the scrambler initial value read from the medium agrees with a scrambler initial value written on the memory.

What is claimed is:

1. An information storage apparatus, comprising:
a head for writing/reading information;
a recording medium provided with data sectors in which user data are written; and
a signal processing circuit for changing a coding form of the user data at every overwrite operation in the same data sector or for changing a scrambler initial value to be applied to the user data at every overwrite operation in the same data sector.

2. The information storage apparatus according to claim 1, wherein the signal processing circuit for changing the coding form of the user data has a plurality of different coding circuits, means for designating one of the plurality of different coding circuits to perform coding of the user data, storage means for storing information corresponding to the plurality of different coding circuits and position information of the data sector, and a controller for controlling a read/write operation; and at the time of a write operation with respect to a data sector which is designated by the controller and in which the write operation is performed, the coding circuit designated at the previous recording is identified from the position information stored in the storage means and the information corresponding to the coding circuit, a circuit different from the coding circuit designated at the previous recording is designated, and the coding form is changed to make coding of the user data, which are then written on the recording medium.

3. The information storage apparatus according to claim 1, wherein the signal processing circuit for changing the coding form of the user data has first storage means in which a plurality of different coding forms are stored, means for selecting one of the plurality of different coding forms and perform coding of the user data, second storage means for storing information corresponding to the plurality of different coding forms and position information of the data sector, and a controller for controlling write/read operations; and at the time of a write operation with respect to a data sector which is designated by the controller and in which the write operation is performed, the coding form applied to the data sector at the previous recording is identified in view of the position information stored in the second storage means and the information corresponding to the coding form, a coding form different from the coding form applied at the previous recording is designated from the first storage means, and the coding form is changed to make coding of the user data, which are then written on the recording medium.

4. The information storage apparatus according to claim 1, wherein the signal processing circuit for changing the coding form of the user data includes means for counting a frequency of writing in a data sector, a plurality of different coding circuits to which numbers are allotted, means for identifying and designating the plurality of coding circuits, storage means for storing position information of the data sector and the frequency of writing, and a controller for controlling write/read operations; and at the time of a write operation with respect to a data sector which is designated by the controller and in which the write operation is performed, the frequency of writing and the frequency of writing stored in the storage means are compared to identify the coding circuit designated at the previous recording, a circuit different from the coding circuit designated at the previous recording is designated to change the coding form, and the user data are coded and written on the recording medium.

5. The information storage apparatus according to claim 1, wherein the signal processing circuit for changing the coding form of the user data includes means for counting a frequency of writing in a data sector, first storage means for storing a plurality of different coding forms with numbers allotted, means for identifying the numbers allotted to the plurality of different coding forms and designating one of them, means for using one of the plurality of coding forms to code the user data, second storage means for storing the position information of the data sector and the frequency of writing, and a controller for controlling write/read operations; and at the time of a write operation with respect to a data sector which is designated by the controller and in which the write operation is performed, the frequency of writing and the frequency of writing stored in the second storage means are compared to identify a number corresponding to the coding form designated at the previous recording, a coding form different from the coding form designated at the previous recording is designated from the first storage means, and the coding form is changed to make coding of the user data, which are then written on the recording medium.

6. The information storage apparatus according to claim 2, wherein at the time of a write operation, information corresponding to a newly selected coding circuit and the position information of the data sector are stored in the storage means, and information corresponding to a newly designated coding circuit is written in the data sector designated by the controller.

7. The information storage apparatus according to claim 3, wherein at the time of a write operation, information corresponding to the newly selected coding form and the position information of the data sector are stored in the second storage means, and information corresponding to the newly designated coding form is written in the data sector designated by the controller.

8. The information storage apparatus according to claim 4, wherein at the time of a write operation, the frequency of writing in the data sector and the position information of the data sector in which another write operation is performed are stored in the storage means.

9. The information storage apparatus according to claim 5, wherein at the time of a write operation, the frequency of writing in the data sector and the position information of the data sector in which another write operation is performed are stored in the second storage means.

10. The information storage apparatus according to claim 2, wherein at the time of a read operation with respect to the data sector designated by the controller, information corresponding to one of the plurality of different coding circuits stored in the storage means and information corresponding to one of the plurality of different coding circuits stored in the data sector are compared, and the read data is sent to the controller when they agree with each other.

11. The information storage apparatus according to claim 3, wherein at the time of a read operation with respect to the data sector designated by the controller, information corresponding to one of the plurality of different coding form stored in the second storage means and information corresponding to one of the plurality of different coding form stored in the data sector are compared, and the read data is sent to the controller when they agree with each other.

12. The information storage apparatus according to claim 4, wherein at the time of a read operation with respect to the data sector designated by the controller, the frequency of writing stored in the storage means and the frequency of writing stored in the data sector are compared, and the read data is sent to the controller when they agree with each other.

13. The information storage apparatus according to claim 5, wherein at the time of a read operation with respect to the data sector designated by the controller, the frequency of writing stored in the second storage means and the frequency of writing stored in the data sector are compared, and the read data is sent to the controller when they agree with each other.

14. The information storage apparatus according to claim 2, wherein the coding form supplied by the plurality of coding form or coding circuits has a constant code rate.

15. The information storage apparatus according to claim 1, wherein the coding form supplied by the signal processing circuit has a constant code rate.

16. An information storage apparatus, comprising:
a head for writing/reading information;
a recording medium provided with data sectors in which user data are written;
means for scrambling the user data;
first storage means for storing a plurality of different scrambler initial values;
means for designating a scrambler initial value from the first storage means, second storage means for storing the scrambler initial value and position information of the data sector; and
a controller for controlling write/read operations,
wherein at the time of a read operation with respect to the data sector designated by the controller, the scrambler initial value designated at the previous recording is identified in view of the position information and the scrambler initial value stored in the second storage means, and a scrambler initial value other than the scrambler initial value is designated from the first storage means to scramble the user data, which are then written in the recording medium.

17. An information storage apparatus, comprising:
a head for writing/reading information;
a recording medium provided with data sectors in which user data are written;
means for counting a frequency of writing in the data sectors;
means for scrambling the user data;
means for identifying a plurality of different scrambler initial values with numbers allotted and designating one of them;
storage means for storing the position information of the data sectors and the frequency of writing; and
a controller for controlling write/read operations,
wherein at the time of a write operation with respect to the data sector designated by the controller, the frequency of writing and the frequency of writing stored in the storage means are compared to identify the scrambler initial value designated at the previous recording, and the user data are scrambled by a scrambler initial value other than the previously designated scrambler initial values and recorded on the recording medium.

18. The information storage apparatus according to claim 16, wherein at the time of a write operation, a newly designated scrambler initial value and the position information of the data sector designated by the controller are stored in the second storage means, and the newly designated scrambler initial value is written in the data sector designated by the controller.

19. The information storage apparatus according to claim 16, wherein at the time of a read operation with respect to the data sector designated by the controller, the scrambler initial values stored in the second storage means and the data sector are compared, and the read data is sent to the controller when they agree with each other.
